(19) United States
(12) Patent Application Publication
(10) Pub. No.: US 2023/0061206 A1
(43) Pub. Date: Mar. 2, 2023

(54) SYSTEMS AND METHODS FOR REINFORCEMENT LEARNING WITH LOCAL STATE AND REWARD DATA

(71) Applicant: ROYAL BANK OF CANADA, Toronto (CA)

(72) Inventors: Hasham BURHANI, Oshawa (CA); Xiao Qi SHI, Richmond Hill (CA)

(21) Appl. No.: 17/411,636

(22) Filed: Aug. 25, 2021

(51) Int. Cl. G06N 3/08; G06N 3/04

(52) U.S. Cl. CPC G06N 3/08; G06N 3/0454

(57) ABSTRACT

Systems are methods are provided for training an automated agent. The automated agent maintains a reinforcement learning neural network and generates, according to outputs of the reinforcement learning neural network, signals for communicating resource task requests. The system includes a communication interface, a processor, memory, and software code stored in the memory. The software code, when executed, causes the system to: instantiate an automated agent that maintains the reinforcement learning neural network; receive current state data of a resource for a first task; receive historical state metrics of the resource computed based on a plurality of historical tasks; compute normalized state data based on the current state data; and provide the historical state metrics and the normalized state data to the reinforcement learning neural network of said automated agent for training.

### FIELD

The present disclosure generally relates to the field of computer processing and reinforcement learning.

### BACKGROUND

Input data for training a reinforcement learning neural network can include state data, or also known as features, as well as reward. The state data and reward may be computed for provision into the neural network. However, for a neural network that is trained to generate commands or decisions on different types of resources, conventional state data and reward may not be sufficient to distinguish one type of resource from another.

### SUMMARY

In accordance with an aspect, there is provided a computer-implemented system for training an automated agent. The system includes a communication interface, at least one processor, memory in communication with the at least one processor, and software code stored in the memory. The software code, when executed at the at least one processor causes the system to: instantiate a first automated agent that maintains a reinforcement learning neural network and generates, according to outputs of said reinforcement learning neural network, signals for communicating resource task requests; receive, by way of said communication interface, current state data of a resource for a first task completed in response to a resource task request communicated by said first automated agent; receive, by way of said communication interface, historical state metrics of the resource computed based on a plurality of historical tasks completed in response to a plurality of resource task requests; compute normalized state data based on the current state data; and provide the historical state metrics and the normalized state data to the reinforcement learning neural network of said first automated agent for training.

In some embodiments, the historical state metrics of the resource are stored in a database and includes at least one of: an average historical state metric of the resource, a standard deviation of the average historical state metric, and a normalized value based on the average historical state metric and the standard deviation.

In some embodiments, the resource is a security, and the historical state metrics and the normalized state data each includes a respective slippage of the security.

In some embodiments, computing the normalized state data based on the current state data may include: computing normalized current state data based on the current state data; and computing the normalized state data based on the normalized current state data and the current state data.

In some embodiments, the software code, when executed at said at least one processor, causes said system to: instantiate a second automated agent that maintains a second reinforcement learning neural network and generates, according to outputs of said second reinforcement learning neural network, signals for communicating resource task requests;

receive, by way of said communication interface, second current state data of the resource for a second task completed in response to a resource task request communicated by said second automated agent, wherein the second task and the first task are completed concurrently; receive, by way of said communication interface, the historical state metrics of the resource; compute a second normalized state data based on the second current state data; and provide the historical state metrics and the second normalized state data to the second reinforcement learning neural network of said second automated agent for training.

In some embodiments, the software code, when executed at said at least one processor, causes said system to: receive, by way of said communication interface, a plurality of local state metrics from said first automated agent; and compute the second normalized state data based on at least the second current state data and the plurality of local state metrics from said first automated agent.

In some embodiments, the software code, when executed at said at least one processor, causes said system to: receive, by way of said communication interface, current reward data of the resource for the first task; receive, by way of said communication interface, historical reward metrics of the resource computed based on the plurality of historical tasks; compute normalized reward data based on the current reward data; and provide the historical reward metrics and the normalized reward data to the reinforcement learning neural network of said automated agent for training.

In some embodiments, the historical reward metrics of the resource is stored in the database and comprises at least one of: an average historical reward metric of the resource, a standard deviation of the average historical reward metric, and a normalized value based on the average historical reward metric and the standard deviation of the average historical reward metric.

In some embodiments, computing the normalized reward data based on the current reward data may include: computing a normalized current reward data based on the current reward data; and computing the normalized reward data based on the normalized current reward data and the current reward data.

In some embodiments, the resource is a security, and the historical reward metrics and the normalized reward data each comprises at least a respective value determined based on a slippage of the security.

In accordance with another aspect, there is provided a computer-implemented method of training an automated agent. The method includes: instantiating an automated agent that maintains a reinforcement learning neural network and generates, according to outputs of said reinforcement learning neural network, signals for communicating resource task requests; receiving, by way of said communication interface, current state data of a resource for a first task completed in response to a resource task request communicated by said automated agent; receiving, by way of said communication interface, historical state metrics of the resource computed based on a plurality of historical tasks completed in response to a plurality of resource task requests; computing a normalized state data based on the current state data; and providing the historical state metrics and the normalized state data to the reinforcement learning neural network of said automated agent for training.

In some embodiments, the method further include: receiving, by way of said communication interface, a plurality of local state metrics from said first automated agent; and computing the second normalized state data based on at least the second current state data and the plurality of local state metrics from said first automated agent.

In some embodiments, the historical state metrics of the resource are stored in a database and includes at least one of: an average historical state metric of the resource, a standard deviation of the average historical state metric, and a normalized value based on the average historical state metric and the standard deviation.

In some embodiments, the resource is a security, and the historical state metrics and the normalized state data each includes a respective slippage of the security.

In some embodiments, computing the normalized state data based on the current state data may include: computing a normalized current state data based on the current state data; and computing the normalized state data based on the normalized current state data and the current state data.

In some embodiments, the method may include: instantiating a second automated agent that maintains a second reinforcement learning neural network and generates, according to outputs of said second reinforcement learning neural network, signals for communicating resource task requests; receiving, by way of said communication interface, second current state data of the resource for a second task completed in response to a resource task request communicated by said second automated agent; receiving, by way of said communication interface, the historical state metrics of the resource; computing a second normalized state data based on the second current state data; and providing the historical state metrics and the second normalized state data to the second reinforcement learning neural network of said second automated agent for training.

In some embodiments, the second task and the first task are completed concurrently.

In some embodiments, the method may further include: receiving, by way of said communication interface, a plurality of local state metrics from said first automated agent; and computing the second normalized state data based on at least the second current state data and the plurality of local state metrics from said first automated agent.

In some embodiments, the method may include: receiving, by way of said communication interface, current reward data of the resource for the first task; receiving, by way of said communication interface, historical reward metrics of the resource computed based on the plurality of historical tasks; computing a normalized reward data based on the current reward data; and providing the historical reward metrics and the normalized reward data to the reinforcement learning neural network of said automated agent for training.

In some embodiments, the historical reward metrics of the resource is stored in the database and includes at least one of: an average historical reward metric of the resource, a standard deviation of the average historical reward metric, and a normalized value based on the average historical reward metric and the standard deviation of the average historical reward metric.

In some embodiments, the resource is a security, and the historical reward metrics and the normalized reward data each comprises at least a respective value determined based on a slippage of the security.

In some embodiments, computing the normalized reward data based on the current reward data may include: computing a normalized current reward data based on the current reward data; and computing the normalized reward data based on the normalized current reward data and the current reward data.

In accordance with yet another aspect, there is provided a non-transitory computer-readable storage medium storing instructions. The instructions, when executed, adapt at least one computing device to: instantiate an automated agent that maintains a reinforcement learning neural network and generates, according to outputs of said reinforcement learning neural network, signals for communicating resource task requests; receive, by way of said communication interface, current state data of a resource for a first task completed in response to a resource task request communicated by said automated agent; receive, by way of said communication interface, historical state metrics of the resource computed based on a plurality of historical tasks completed in response to a plurality of resource task requests; compute normalized state data based on the current state data; and provide the historical state metrics and the normalized state data to the reinforcement learning neural network of said automated agent for training.

In some embodiments, the resource is a security, and the historical state metrics and the normalized state data each includes a respective slippage of the security.

In some embodiments, the instructions, when executed, adapt the at least one computing device to: instantiate a second automated agent that maintains a second reinforcement learning neural network and generates, according to outputs of said second reinforcement learning neural network, signals for communicating resource task requests; receive, by way of said communication interface, second current state data of the resource for a second task completed in response to a resource task request communicated by said second automated agent, wherein the second task and the first task are completed concurrently; receive, by way of said communication interface, the historical state metrics of the resource; compute a second normalized state data based on the second current state data; and provide the historical state metrics and the second normalized state data to the second reinforcement learning neural network of said second automated agent for training.

In some embodiments, the instructions, when executed, adapt the at least one computing device to: receive, by way of said communication interface, current reward data of the resource for the first task; receive, by way of said communication interface, historical reward metrics of the resource computed based on the plurality of historical tasks; compute normalized reward data based on the current reward data; and provide the historical reward metrics and the normalized reward data to the reinforcement learning neural network of said first automated agent for training.

In accordance with another aspect, there is provided a trade execution platform integrating a reinforcement learning process based on the methods as described above.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

In the Figures, which illustrate example embodiments,

FIG. 1A is a schematic diagram of a computer-implemented system for training an automated agent, exemplary of embodiments.

FIG. 1B is a schematic diagram of an automated agent, exemplary of embodiments.

FIG. 2 is a schematic diagram of an example neural network maintained at the computer-implemented system of FIG. 1A.

FIG. 3 is a schematic diagram showing an example process with state data and reward normalization for training the neural network of FIG. 2.

FIG. 4 is a schematic diagram of a system having a plurality of automated agents, exemplary of embodiments.

FIG. 5 is a flowchart of an example method of training an automated agent based on state data, exemplary of embodiments.

FIG. 6 is a flowchart of an example method of training an automated agent based on reward data, exemplary of embodiments.

### DETAILED DESCRIPTION

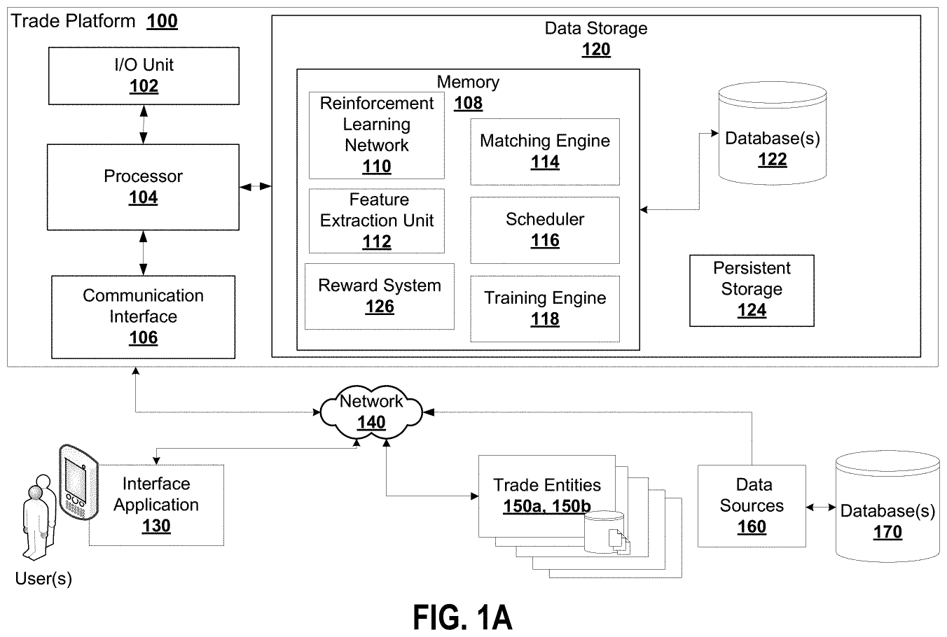

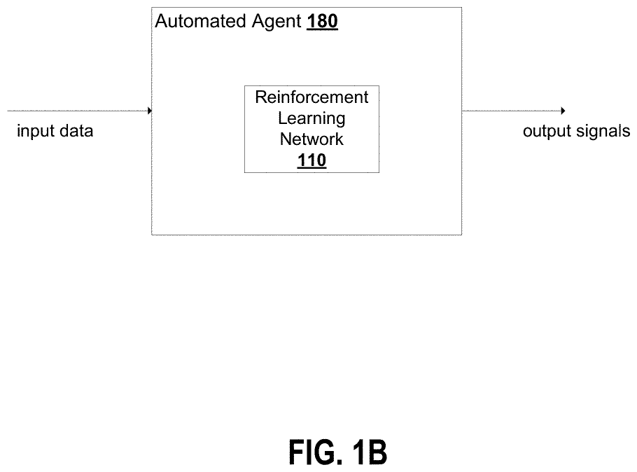

FIG. 1A is a high-level schematic diagram of a computer-implemented system 100 for training an automated agent having a neural network, exemplary of embodiments. The automated agent is instantiated and trained by system 100 in manners disclosed herein to generate task requests.

As detailed herein, in some embodiments, system 100 includes features adapting it to perform certain specialized purposes, e.g., to function as a trading platform. In such embodiments, system 100 may be referred to as trading platform 100 or simply as platform 100 for convenience. In such embodiments, the automated agent may generate requests for tasks to be performed in relation to securities (e.g., stocks, bonds, options or other negotiable financial instruments). For example, the automated agent may generate requests to trade (e.g., buy and/or sell) securities by way of a trading venue.

Referring now to the embodiment depicted in FIG. 1A, trading platform 100 has data storage 120 storing a model for a reinforcement learning neural network. The model is used by trading platform 100 to instantiate one or more automated agents 180 (FIG. 1B) that each maintain a reinforcement learning neural network 110 (which may be referred to as a reinforcement learning network 110 or network 110 for convenience).

A processor 104 is configured to execute machine-executable instructions to train a reinforcement learning network 110 based on a reward system 126. The reward system generates good (or positive) signals and bad (or negative) signals to train automated agents 180 to perform desired tasks more optimally, e.g., to minimize and maximize certain performance metrics. In some embodiments, an automated agent 180 may be trained by way of signals generated in accordance with reward system 126 to minimize Volume Weighted Average Price (VWAP) slippage. For example, reward system 126 may implement rewards and punishments substantially as described in U.S. patent application Ser. No. 16/426,196, entitled “Trade platform with reinforcement learning”, filed May 30, 2019, the entire contents of which are hereby incorporated by reference herein.

In some embodiments, trading platform 100 can generate reward data by normalizing the differences of the plurality of data values (e.g. VWAP slippage), using a mean and a standard deviation of the distribution.

Throughout this disclosure, it is to be understood that the terms “average” and “mean” refer to an arithmetic mean, which can be obtained by dividing a sum of a collection of numbers by the total count of numbers in the collection.

In some embodiments, trading platform 100 can normalize input data for training the reinforcement learning network 110. The input normalization process can involve a feature extraction unit 112 processing input data to generate different features such as pricing features, volume features, time features, Volume Weighted Average Price features, market spread features. The pricing features can be price comparison features, passive price features, gap features, and aggressive price features. The market spread features can be spread averages computed over different time frames. The Volume Weighted Average Price features can be current Volume Weighted Average Price features and quoted Volume Weighted Average Price features. The volume features can be a total volume of an order, a ratio of volume remaining for order execution, and schedule satisfaction. The time features can be current time of market, a ratio of time remaining for order execution, and a ratio of order duration and trading period length.

The input normalization process can involve computing upper bounds, lower bounds, and a bounds satisfaction ratio; and training the reinforcement learning network using the upper bounds, the lower bounds, and the bounds satisfaction ratio. The input normalization process can involve computing a normalized order count, a normalized market quote and/or a normalized market trade. The platform 100 can have a scheduler 116 configured to follow a historical Volume Weighted Average Price curve to control the reinforcement learning network 110 within schedule satisfaction bounds computed using order volume and order duration.

The platform 100 can connect to an interface application 130 installed on user device to receive input data. Trade entities 150a, 150b can interact with the platform to receive output data and provide input data. The trade entities 150a, 150b can have at least one computing device. The platform 100 can train one or more reinforcement learning neural networks 110. The trained reinforcement learning networks 110 can be used by platform 100 or can be for transmission to trade entities 150a, 150b, in some embodiments. The platform 100 can process trade orders using the reinforcement learning network 110 in response to commands from trade entities 150a, 150b, in some embodiments.

The platform 100 can connect to different data sources 160 and databases 170 to receive input data and receive output data for storage. The input data can represent trade orders. Network 140 (or multiple networks) is capable of carrying data and can involve wired connections, wireless connections, or a combination thereof. Network 140 may involve different network communication technologies, standards and protocols, for example.

The platform 100 can include an I/O unit 102, a processor 104, communication interface 106, and data storage 120. The I/O unit 102 can enable the platform 100 to interconnect with one or more input devices, such as a keyboard, mouse, camera, touch screen and a microphone, and/or with one or more output devices such as a display screen and a speaker.

The processor 104 can execute instructions in memory 108 to implement aspects of processes described herein. The processor 104 can execute instructions in memory 108 to configure a data collection unit, interface unit (to provide control commands to interface application 130), reinforcement learning network 110, feature extraction unit 112, matching engine 114, scheduler 116, training engine 118, reward system 126, and other functions described herein. The processor 104 can be, for example, any type of general-purpose microprocessor or microcontroller, a digital signal processing (DSP) processor, an integrated circuit, a field programmable gate array (FPGA), a reconfigurable processor, or any combination thereof.

As depicted in FIG. 1B, automated agent 180 receives input data (via a data collection unit) and generates output signal according to its reinforcement learning network 110 for provision to trade entities 150a, 150b. Reinforcement learning network 110 can refer to a neural network that implements reinforcement learning.

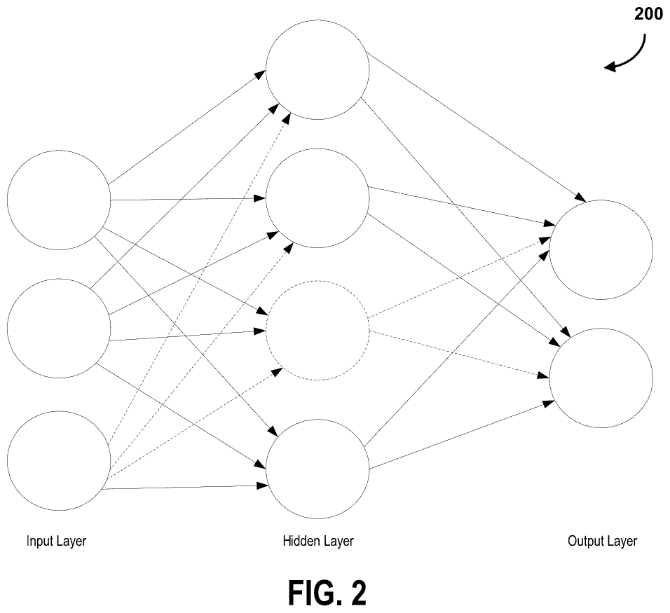

FIG. 2 is a schematic diagram of an example neural network 200 according to some embodiments. The example neural network 200 can include an input layer, a hidden layer, and an output layer. The neural network 200 processes input data using its layers based on reinforcement learning, for example.

Reinforcement learning is a category of machine learning that configures agents, such the automated agents 180 described herein, to take actions in an environment to maximize a notion of a reward. The processor 104 is configured with machine executable instructions to instantiate an automated agent 180 that maintains a reinforcement learning neural network 110 (also referred to as a reinforcement learning network 110 for convenience), and to train the reinforcement learning network 110 of the automated agent 180 using a training unit 118. The processor 104 is configured to use the reward system 126 in relation to the reinforcement learning network 110 actions to generate good signals and bad signals for feedback to the reinforcement learning network 110. In some embodiments, the reward system 126 generates good signals and bad signals to minimize Volume Weighted Average Price slippage, for example. Reward system 126 is configured to receive control the reinforcement learning network 110 to process input data in order to generate output signals. Input data may include trade orders, various feedback data (e.g., rewards), or feature selection data, or data reflective of completed tasks (e.g., executed trades), data reflective of trading schedules, etc. Output signals may include signals for communicating resource task requests, e.g., a request to trade in a certain security. For convenience, a good signal may be referred to as a “positive reward” or simply as a reward, and a bad signal may be referred as a “negative reward” or as a punishment.

Referring again to FIG. 1, feature extraction unit 112 is configured to process input data to compute a variety of features. The input data can represent a trade order. Example features include pricing features, volume features, time features, Volume Weighted Average Price features, market spread features. These features may be processed to compute state data, which can be a state vector. The state data may be used as input to train the automated agent(s) 108.

Matching engine 114 is configured to implement a training exchange defined by liquidity, counter parties, market makers and exchange rules. The matching engine 114 can be a highly performant stock market simulation environment designed to provide rich datasets and ever changing experiences to reinforcement learning networks 110 (e.g. of agents 180) in order to accelerate and improve their learning. The processor 104 may be configured to provide a liquidity filter to process the received input data for provision to the machine engine 114, for example. In some embodiments, matching engine 114 may be implemented in manners substantially as described in U.S. patent application Ser. No. 16/423,082, entitled “Trade platform with reinforcement learning network and matching engine”, filed May 27, 2019, the entire contents of which are hereby incorporated herein.

Scheduler 116 is configured to follow a historical Volume Weighted Average Price curve to control the reinforcement learning network 110 within schedule satisfaction bounds computed using order volume and order duration.

The interface unit 130 interacts with the trading platform 100 to exchange data (including control commands) and generates visual elements for display at user device. The visual elements can represent reinforcement learning networks 110 and output generated by reinforcement learning networks 110.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 120 can include memory 108, databases 122, and persistent storage 124.

The communication interface 106 can enable the platform 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The platform 100 can be operable to register and authenticate users (using a login, unique identifier, and password for example) prior to providing access to applications, a local network, network resources, other networks and network security devices. The platform 100 may serve multiple users which may operate trade entities 150a, 150b.

The data storage 120 may be configured to store information associated with or created by the components in memory 108 and may also include machine executable instructions. The data storage 120 includes a persistent storage 124 which may involve various types of storage technologies, such as solid state drives, hard disk drives, flash memory, and may be stored in various formats, such as relational databases, non-relational databases, flat files, spreadsheets, extended markup files, etc.

A reward system 126 integrates with the reinforcement learning network 110, dictating what constitutes good and bad results within the environment. In some embodiments, the reward system 126 is primarily based around a common metric in trade execution called the Volume Weighted Average Price (“VWAP”). The reward system 126 can implement a process in which VWAP is normalized and converted into the reward that is fed into models of reinforcement learning networks 110. The reinforcement learning network 110 processes one large order at a time, denoted a parent order (i.e. Buy 10000 shares of RY.TO), and places orders on the live market in small child slices (i.e. Buy 100 shares of RY.TO@110.00). A reward can be calculated on the parent order level (i.e. no metrics are shared across multiple parent orders that the reinforcement learning network 110 may be processing concurrently) in some embodiments.

To achieve proper learning, the reinforcement learning network 110 is configured with the ability to automatically learn based on good and bad signals. To teach the reinforcement learning network 110 how to minimize VWAP slippage, the reward system 126 provides good and bad signals to minimize VWAP slippage.

The reward system 126 can normalize the reward for provision to the reinforcement learning network 110. The processor 104 is configured to use the reward system 126 to process input data to generate Volume Weighted Average Price data. The input data can represent a parent trade order. The reward system 126 can compute reward data using the Volume Weighted Average Price and compute output data by processing the reward data using the reinforcement learning network 110. In some embodiments, reward normalization may involve transmitting trade instructions for a plurality of child trade order slices based on the generated output data.

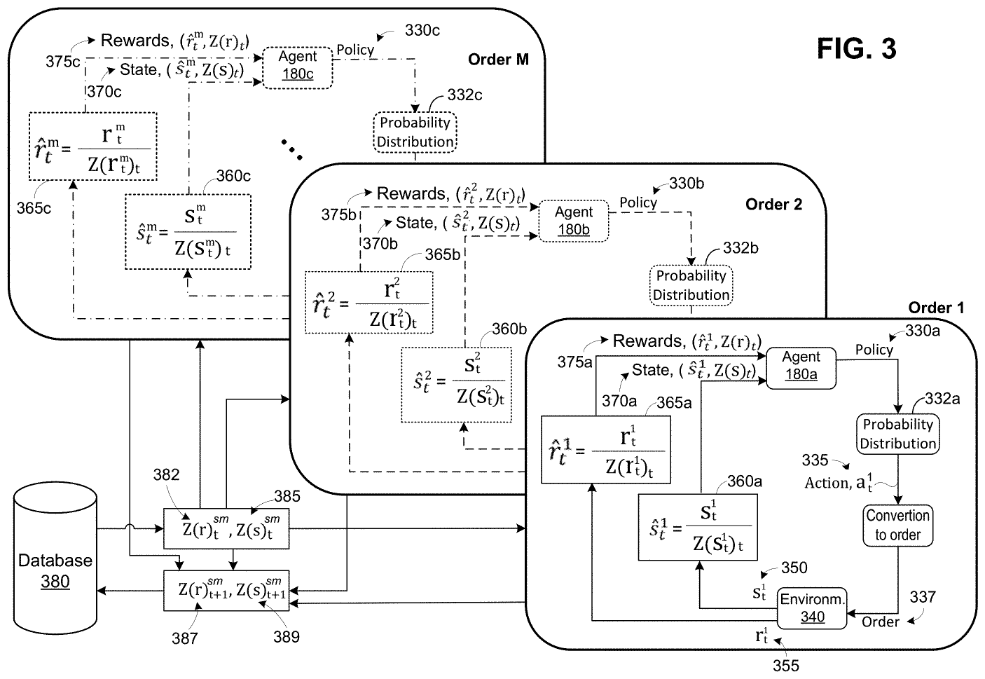

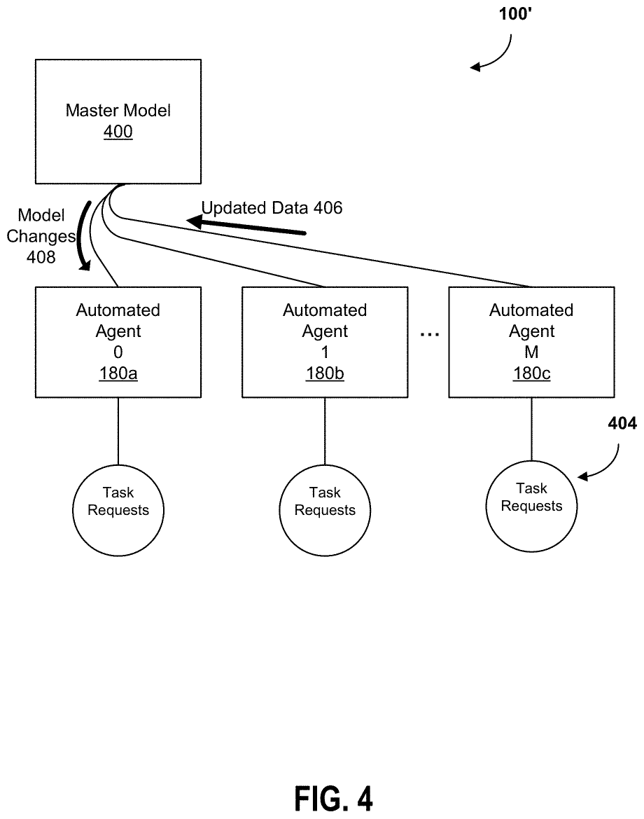

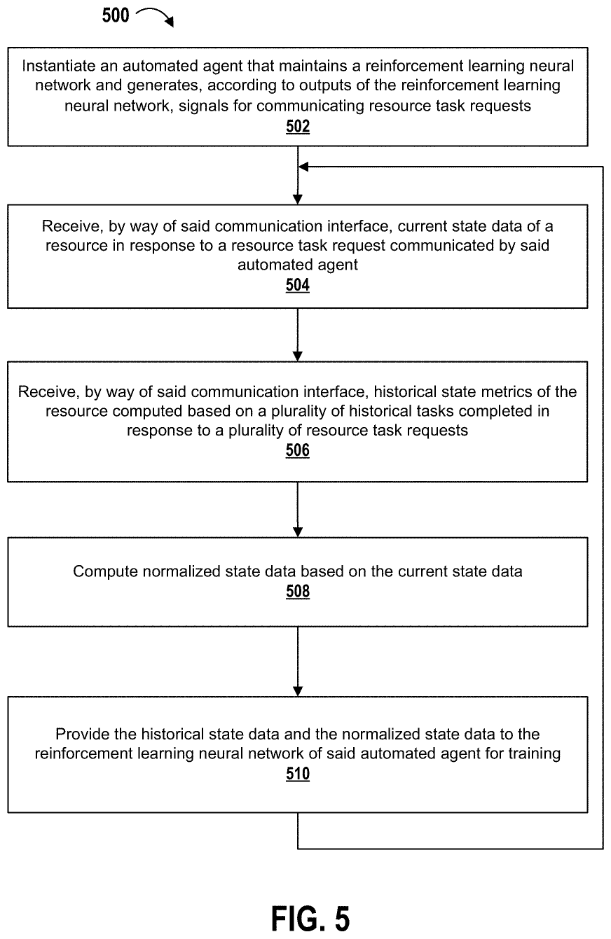

FIG. 3 illustrates a schematic diagram showing an example process with self-awareness inputs for training the neural network of FIG. 2. At any given point in time, there may be multiple instances of automated agents 180a, 180b, 180c, each performing a process as described below. More specifically, an agent 180a, 180b, 180c may be configured to generate a signal representing a resource task request based on a given set of input (e.g., reward and state data), where the signal may cause a task (e.g., an order 337) to be executed and completed. Each agent 180a, 180b, 180c may, respectively and concurrently, cause a respective order 337 to be executed, for example, agent 180a may cause order 1 to be executed, agent 180b may cause order 2 to be completed . . . and agent 180c may cause order M to be completed, in the same time period, which may be a minute, half a minute, a second, half a second, or even 1/10^{th} of a second. A multi-agent platform 100′ is illustrated in FIG. 4. It is to be appreciated that the process described below and illustrated in FIG. 5 include operations and steps performed by each of the agents 180a, 180b, 180c during each iteration of resource task request and action/order execution.

In some embodiments, as shown in FIG. 3, an automated agent 180a, with a given set of input including reward 375a and state data 370a at time t=t₀, may take an action αₜ_{₀}¹ 335 based on an existing policy 330a. Generally speaking, state data 370a can be a state vector representing the current environment 340 for the agent 180a at a given point in time. For example, the policy 330a can be a probability distribution function 332a, which determines that the action aₜ_{₀}¹ 335 is to be taken at the current point in time t₀, under the state defined by the state data 370a, in order to maximize the reward 375a.

For another example, agent 180b or 180c, which may run in parallel to agent 180a, may use an appropriate policy 330b or 330c (e.g., a probability distribution function 332a or 332b) to determine that a respective action (not shown in FIG. 3) is to be taken at the current point in time, under the state defined by the state data 370b or 370c, in order to maximize the reward 375b or 375c.

Referring back to agent 180a, the action aₜ_{₀}¹ 335 may be a resource task request, at time t₀ for a specific resource (e.g., a security X), which can be, for example, “purchase security X at price Y”. The resource task request in the depicted embodiment may lead to, or convert to an executed order 337 for the specific resource X. The executed order 337 then leads to a change of the environment 340, which can be the simulated stock market during training of the neural network.

Next, at time step t=t₁, platform 100 receives or generates current state data sₜ¹ 350, which may be normalized or unnormalized, based on raw task data from the environment 340, which may be, for example, a trading venue or indirectly by way of an intermediary. Current state data sₜ¹ 350 can include data relating to tasks or orders 337 completed in a given time interval (e.g., t₀ to t₁, t₁ to t₂, . . . , tₙ₋₁ to tₙ) in connection with a given resource (e.g., the security X). For example, orders 337 may include trades of a given security in the time interval. In this circumstance, current state data sₜ¹ 350 can include values of the given security X such as prices and volumes of trades, as well as a slippage value based on the trades. In some embodiment, current state data sₜ¹ 350 includes values for prices and volumes for tasks completed in response to previous requests (e.g., previous resource task requests) communicated by an automated agent 180a and for tasks completed in response to requests by other entities (e.g., the rest of the market) relating to the given resource, e.g., security X. Such other entities may include, for example, other automated agents 180b, 180c or human traders.

In some embodiments, a feature extraction unit 112 (see e.g., FIG. 1) of platform 100 may be configured to generate the current state data sₜ¹ 350 by processing raw task data relating to at least one trade order 337 from the environment 340, of the security X. The current state data sₜ¹ 350 can include feature data generated as a consequence of the action aₜ_{₀}¹ 335 (e.g., the most recently executed order 337) by the agent 180a from the previous time stamp. The current state data sₜ¹ 350 may include feature data representing a variety of features for the given resource (e.g., security). The feature data can include part or all relevant data from the trade order 337. Example feature data include pricing features, volume features, time features, Volume Weighted Average Price features, a slippage value, and market spread features. These features may be processed to compute the current state data sₜ¹ 350, which can be a state vector. The current state data sₜ¹ 350 may be processed and included as part of state data 370a, which is used as input to train the automated agent 180a.

In some examples, current state data sₜ¹ 350 may relate to a single feature or a single resource, i.e., data for a specific feature relevant to the specific resource, e.g., security X. When the resource is a security, the feature may be, as a non-limiting example, a volatility, a mid-point price, a slippage value, or a market spread of the security.

In addition to the current state data sₜ¹ 350, at each time step t=t₁, a reward system 126 can process raw data from the environment 340 to calculate performance metrics, which may be represented as current reward data sₜ¹ 355, that measures the performance of an automated agent 180a for an order just completed in the immediately previous time step. In some embodiments, current reward data rₜ¹ 355 can measure the performance of an automated agent 180a relative to the market 340 (i.e., including the aforementioned other entities). The current reward data sₜ¹ 355 may be processed and included as part of reward 375a, which is used as input to train the automated agent 180a. For example, the current reward data rₜ¹ 355 may be determined based on a slippage value of a security resource of a previously completed order 337.

In some embodiments, each time interval (i.e., time between each of t₀ to t₁, t₁ to t₂, t₂ to t₃, . . . , tₙ₋₁ to tₙ) is substantially less than one day. In one particular embodiment, each time interval has a duration between 0-6 hours. In one particular embodiment, each time interval has a duration less than 1 hour. In one particular embodiment, a median duration of the time intervals is less than 1 hour. In one particular embodiment, a median duration of the time intervals is less than 1 minute. In one particular embodiment, a median duration of the time interval is less than 1 second.

As will be appreciated, having a time interval substantially less than one day provides opportunity for automated agents 180a, 180b, 180c to learn and change how task requests are generated over the course of a day. In some embodiments, the duration of the time interval may be adjusted in dependence on the volume of trade activity for a given trade venue. In some embodiments, duration of the time interval may be adjusted in dependence on the volume of trade activity for a given resource.

The platform 100, also at time t=t₁, may receive, from a database 380, historical state metrics Z(s)ₜ^{sm} 385 of the specific resource, e.g., security X. The specific resource can be represented by a stock symbol, e.g., SM, throughout the database 380 and recognized by the automated agents 180a, 180b, 180c. The historical state metrics Z(s)ₜ^{sm} 385 computed based on a plurality of historical tasks completed in response to a plurality of resource task requests, which may be communicated by one or more automated agents 180a, 180b, 180c. The plurality of historical tasks relate to the specific resource represented by the stock symbol SM. In some cases, some of the plurality of historical tasks may be performed by human traders. The historical state metrics Z(s)ₜ^{sm} 385 may include, for example, data computed based on historical feature data generated as a consequence of previous actions (e.g., previous orders executed based on previous resource task requests) on the specific resource represented by the stock symbol SM, by the one or more automated agents 180a, 180b, 180c in the environment 340. In some embodiments, the historical state metrics Z(s)ₜ^{sm} 385 may include a most up-to-date average (e.g., mean) value and standard deviations of previous state data 370a relating to the specific resource by all agents 180a, 180b, 180c in the environment 340.

Similarly, the platform 100, at time t=t₁, may receive, from the database 380, historical reward metrics Z(r)ₜ^{sm} 382 of the specific resource, e.g., security X, which may be represented by the stock symbol SM. The historical reward metrics Z(r)ₜ^{sm} 382 can be computed based on a plurality of historical tasks completed in response to a plurality of resource task requests, which may be communicated by one or more automated agents 180a, 180b, 180c. The plurality of historical tasks relate to the specific resource represented by the stock symbol SM. In some cases, some of the plurality of historical tasks may be performed by human traders. In some embodiments, the historical reward metrics Z(r)ₜ^{sm} 382 may include most up-to-date average (e.g., mean) value and standard deviations of previous reward 375a relating to the specific resource by all agents 180a, 180b, 180c in the environment 340.

The historical state metrics Z(s)ₜ^{sm} 385 and historical reward metrics Z(r)ₜ^{sm} 382 may be sent across the platform 100 to all active agents 180a, 180b, 180c in the environment 340, each time an order 337 relating to the specific resource represented by the stock symbol SM is being contemplated (e.g., when a resource task request is generated based on a policy and given a set of input) by an agent. Once the resource task request has been generated and the corresponding order 337 has been completed based on the resource task request, updated historical state metrics Z(s)ₜ₊₁^{sm} 389 and updated historical reward metrics Z(r)ₜ₊₁^{sm} 387 may be generated for the next time step tₜ₊₁, and sent back to the database 380 for storage, for the specific resource represented by the stock symbol SM. With the most up-to-date historical state metrics Z(r)ₜ^{sm} and historical reward metrics Z(r)ₜ^{sm} at any given point in time, an agent 180a, 180b, 180c is able to compare its single order performance to all ongoing and previous orders performance for the specific resource represented by the stock symbol SM.

Even though FIG. 3 only shows the historical state metrics 385, 389 and historical reward metrics 382, 387 for a single resource represented by the stock symbol SM being sent to and transmitted from the database 380, it is to be appreciated that the database 380 stores the historical state metrics and historical reward metrics for a plurality of resources, where each resource may be represented by an unique code such as an unique stock symbol. The automated agents 180a, 180b, 180c is configured to request the appropriate historical state metrics Z(r)ₜ^{sm} 385 and historical reward metrics Z(r)ₜ^{sm} 382 based on the specific resource SM in the ongoing order 337.

In some embodiments, Z may be a transformation function for normalizing the current state data sₜ¹ 350 or the current reward data rₜ¹ 355.

In the interest of improving the stability, and efficacy of the reinforcement learning network 110 model training, then platform 100 can normalize the current state data sₜ¹ 350 and/or the current reward data rₜ¹ 355, of the reinforcement learning network 110 model in a number of ways. Normalization can transform input data into a range or format that is understandable by the model or reinforcement learning network 110.

For example, in some embodiments, the current state data sₜ¹ 350 may be normalized based on a plurality of local state metrics from one or more automated agents 180a, 180b, 180c. For another example, in some embodiments, the current reward data rₜ¹ 355 may be normalized based on a plurality of local reward metrics from one or more automated agents 180a, 180b, 180c. The local state or reward metrics may include values representing features or reward metrics relating to the same resource (e.g., security X represented by the stock symbol SM) in one or more concurrent ongoing orders 337 being performed by the one or more automated agents 180a, 180b, 180c.

Neural networks have very a range of values that inputs have to be in for the neural network to be effective. Input normalization can refer to scaling or transforming input values for provision to neural networks. For example, in some machine learning processes the max/min values can be predefined (pixel values in images) or a computed mean and standard deviation can be used, then the input values to mean 0 and standard deviation of 1 can be converted. In trading, this approach might not work. The mean or the standard deviation of the inputs, can be computed from historical values. However, this may not be the best way to normalize, as the mean or standard deviation can change as the market changes. The platform 100 can address this challenge in a number of different ways for the input space.

For example, for agent 180a, the platform 100 can process the current state data sₜ¹ 350 within a local scope of the order 337, to generate a normalized state data sₜ¹ 360a, and process the current reward data rₜ¹ 355 within a local scope of the order 337, to generate a normalized reward data \hat{r}ₜ¹ 365a. The normalized state data ŝₜ¹ 360a and the normalized reward data \hat{r}ₜ¹ 365a may be provided to the reinforcement learning neural network 110 as part of state data 370a and reward 375a, respectively, to train the automated agent 180a.

In some embodiments, the normalized state data ŝₜ¹ 360a may be computed based on the equation:

$${\hat{s}}_{t}^{1} = \frac{{s}_{t}^{1}}{{Z ( {s}_{t}^{1} )}_{t}}$$

where sₜ¹ is the current state data sₜ¹ 350 for the specific resource or security in the order 337.

In a similar fashion, a normalized state data ŝₜⁿ for an order, where n=1, 2, . . . , m, may be computed based on:

$${\hat{s}}_{t}^{n} = \frac{{s}_{t}^{n}}{{Z ( {s}_{t}^{n} )}_{t}}$$

where sₜⁿ is the current state data sₜ^{m} for the specific resource or security in the order.

In some embodiments, the normalized reward data \hat{r}ₜ¹ 365a may be computed based on the equation:

$${\hat{r}}_{t}^{1} = \frac{{r}_{t}^{1}}{{Z ( {r}_{t}^{1} )}_{t}}$$

where rₜⁿ is the current reward data rₜ¹ 355 for the specific resource or security in the order 337.

In a similar fashion, a normalized reward data \hat{r}ₜⁿ for an order, where n=1, 2, . . . , m, may be computed based on:

$${\hat{r}}_{t}^{n} = \frac{{r}_{t}^{n}}{{Z ( {r}_{t}^{n} )}_{t}}$$

where rₜⁿ is the current reward data rₜⁿ for the specific resource or security in the order.

Next, the normalized state data ŝₜ¹ 360a, along with the historical state metrics Z(s)ₜ^{sm} 385, may be included as part of the most current state data 370a at present time t=t₁. The state data 370a is then relayed to the automated agent 180a as an input. For example, the normalized state data ŝₜ¹ 360a and the historical state metrics Z(r)ₜ^{sm} 385 may each include one or more elements within a state vector representing the state data 370a.

In addition, the normalized reward data \hat{r}ₜ¹ 365a, along with the historical reward metrics Z(r)ₜ^{sm} 382, may be included as part of the most current reward 375a at present time t=t₁. The reward 375a is then relayed to the automated agent 180a as an input. For example, the normalized reward data \hat{r}ₜ¹ 365a and the historical reward metrics Z(r)ₜ^{sm} 382 may each include one or more elements in the reward 375a.

The normalized reward data \hat{r}ₜ¹ 365a, along with the normalized state data ŝₜ¹ 360a enable the agent 180a, to learn based on input that are drive by the agent 180a's own actions in the time period preceding the present time t, normalized within a local scope for a particular resource such as a security X.

Similarly, the normalized reward data \hat{f}ₜ² 365b, along with the normalized state data ŝₜ² 360b, enable the agent 180b to learn based on input that are drive by the agent 180b's own actions in the time period preceding the present time t, normalized within a local scope for the particular resource, and the normalized reward data \hat{r}ₜ^{m} 365c, along with the normalized state data ŝₜ^{m} 360c, enable the agent 180c to learn based on input that are drive by the agent 180c's own actions in the time period preceding the present time t, normalized within a local scope for the particular resource.

In some cases, when multiple (trade) orders 337 are being executed at the same time, or being executed concurrently within one time unit (e.g., t is between t₀ and t₁), the resources, e.g., securities or bonds, involved across the orders can be vastly different. An example current state data 350 for the order may include feature data of a slippage of the security in the order. Slippage can be calculated based on the difference between a trade order's entry or exit order price (e.g., $2 per unit for Y units), and the price at which the trade order is actually filled (e.g., $2.2 per unit for Z units). The slippage of an order may be related to market conditions such as market volatility. To maximize a reward, an automated agent is configured to try to minimize the slippage of each order.

In conventional reinforcement learning frameworks, each agent may learn based on historical data, which may cover a range of orders for different securities in the past. Understandably, each security may have a different average slippage over the same time period. For example, during a past time frame of five hours, Stock A may have an average of $0.5 slippage per unit, while Stock B may have an average of $2 slippage per unit. The performance matrix or the reward may be designed to generate a positive reward when the state data shows that an agent has achieved $0.3 slippage for Stock A based on a historical average. However, when the historical data used to train the agent covers all the stocks including Stock B, and is not normalized based on Stock A's specific price or slippage data, the state data and reward may include an inaccurate historical average on slippage for Stock A, and thus lead to inefficient training of the automated agent.

The disclosed embodiments of platform 100 are configured to compute state data 370a, 370b, 370c and reward 375a, 375b, 375c including historical state metrics Z(r)ₜ^{sm} 385 and reward metrics Z(r)ₜ^{sm} 382, based on the historical data for one particular resource as represented by the stock symbol SM, generated across multiple agents 180a, 180b, 180c in the environment 340. The state data 370a, 370b, 370c and reward 375a, 375b, 375c further include a normalized state data ŝₜⁿ 360a, 360b, 360c and normalized reward data \hat{r}ₜ¹ 365a, 365b, 365c, in order to further anchor the state data 370a, 370b, 370c and reward 375a, 375b, 375c to the local experience of each respective agent 180a, 180b, 180c, to ensure that the state data and reward for the particular agent 180a, 180b, 180c reflect the ongoing and relevant information of the particular stock in the current market conditions.

In the disclosed embodiments, the agent 180a, 180b, 180c learns to adjust its respective policy 330a, 330b, 330c based on how the market responds to its past actions. The agent 180a, 180b, 180c can therefore improve its policy and response by anchoring it within a local range that is determined based on the agent's own past behaviour, which is represented by the respective normalized state data ŝₜⁿ 360a, 360b, 360c and the respective normalized reward data \hat{r}ₜⁿ 365a, ŝₜⁿ 365b, 365c. For instance, if the feature data used for computing the normalized state data ST 360a, 360b, 360c is slippage, the slippage of the resource can be then controlled within a local range, in terms of magnitude and/or direction, as determined by the historical feature data of the resource.

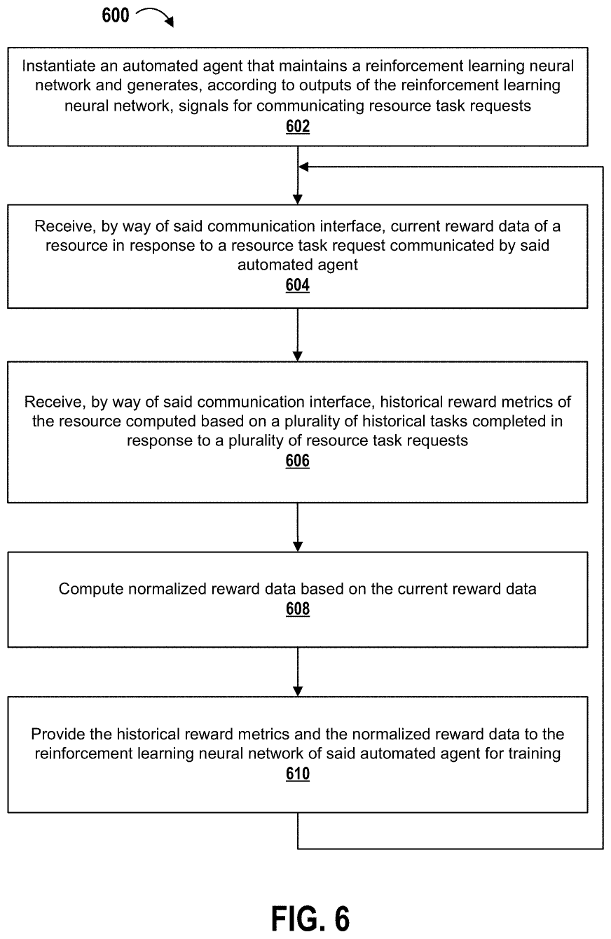

The operation of system 100 is further described with reference to the flowchart illustrated in FIGS. 5 and 6, exemplary of embodiments. As depicted in FIG. 5, trading platform 100 performs operations 500 and onward to train an automated agent 180a, 180b, 180c. Even though each operation or step may be described with reference to agent 180a, it is understood that it can be applied to other agents 180b, 180c of the platform 100.

At operation 502, platform 100 instantiates an automated agent 180a, which may be a first automated agent 180a among many automated agents 180a, 180b, 180c, that maintains a reinforcement learning neural network 110, e.g., using data descriptive of the neural network stored in data storage 120. The automated agent 180a generates, according to outputs of its reinforcement learning neural network, signals for communicating resource task requests for a given resource (e.g., a given security). For example, the automated agent 180a may receive a trade order for a given security as input data and then generate signals for a plurality of resource task requests corresponding to trades for child trade order slices of that security. Such signals may be communicated to a trading venue by way of communication interface 106.

At operation 504, platform 100 receives, by way of communication interface 106, current state data sₜ¹ 350 of a resource for a task completed in response to a resource task request, which may be communicated by said automated agent 180a. A completed task may occur based on the resource task request. For example, the completed task can include completed trades in a given resource (e.g., a given security) based on action aₜ_{₀}¹ 335, and current state data sₜ¹ 350 can include feature data computed based on, for example, values for prices, volumes, volatility, or market spread for the completed trade(s) in the order 337.

At operation 506, platform 100 receives, by way of communication interface 106, historical state metrics Z(s)ₜ^{sm} 385 of the resource represented by the stock symbol SM computed based on a plurality of historical tasks completed in response to a plurality of resource task requests, which may be communicated by one or more automated agents 180a, 180b, 180c. The historical state metrics Z(s)ₜ^{sm} 385 may be stored on a database 380 and retrieved in real time or near real time.

In some embodiments, the historical state metrics Z(s)ₜ^{sm} 385 of the given resource as represented by the stock symbol SM are stored in a database 380 and include one or more: an average historical state metric of the resource, a standard deviation of the average historical state metric, and a normalized value based on the average historical state metric and the standard deviation.

Operations 504 and 506 may be performed concurrently, or operation 506 may be performed ahead of operation 504.

At operation 508, platform 100 computes compute normalized state data ŝₜ¹ 360a based on the current state data sₜ¹ 350. For example, for agent 180a, the platform 100 can process the current state data sₜ¹ 350 within a local scope of the order 337, to generate a normalized state data ŝₜ¹ 360a.

In some embodiments, computing the normalized state data ŝₜ¹ 360a based on the current state data sₜ¹ 350 may include: computing normalized current state data based on the current state data sₜ¹ 350; and computing the normalized state data ŝₜ¹ 360a based on the normalized current state data and the current state data 350.

For example, the normalized state data ŝₜ¹ 360a may be computed based on the equation:

$${\hat{s}}_{t}^{1} = \frac{{s}_{t}^{1}}{{Z ( {s}_{t}^{1} )}_{t}}$$

where sₜ¹ is the current state data sₜ¹ 350 for the specific resource or security in the order 337, and Z(sₜ¹)ₜ is the normalized current state data.

For another example, the current state data sₜ¹ 350 for agent 180a may be normalized based on a plurality of local state metrics from one or more additional automated agents 180b, 180c.

At operation 510, platform 100 provides the normalized state data ŝₜ¹ 360a as part of state data 370a to reinforcement learning neural network 110 of the automated agent 180a to train the automated agent 180a. In some embodiments, state data 370a further includes historical state metrics Z(s)ₜ^{sm} 385.

In some embodiments, the platform 100 updates the historical state metrics Z(s)ₜ₊₁^{sm} 389 of the resource for the next time step t+1 based on the order 337 completed. Where there are multiple agents 180a, 180b, 180c executing multiple orders 337 for the same resource concurrently, the platform 100 can update the historical state metrics Z(s)ₜ₊₁^{sm} 389 of the resource based on the state data of the multiple completed orders 337. The updated historical state metrics Z(s)ₜ₊₁^{sm} 389 may be stored in the database 380.

The training process may continue by repeating operations 504 through 510 for successive time intervals, e.g., until trade orders received as input data are completed. Conveniently, repeated performance of these operations or blocks causes automated agents 180a, 180b, 180c to become further optimized at making resources task requests, e.g., in some embodiments by improving the price of securities traded, improving the volume of securities traded, improving the timing of securities traded, and/or improving adherence to a desired trading schedule. As will be appreciated, the optimization results will vary from embodiment to embodiment.

In some embodiments, platform 100 may perform additional operations including, for example: instantiating a second automated agent 180b that maintains a second reinforcement learning neural network and generates, according to outputs of said second reinforcement learning neural network, signals for communicating resource task requests; receiving, by way of said communication interface 106, second current state data sₜ² of the resource for a second task completed in response to a resource task request communicated by said second automated agent 180b, where the second task and the first task are completed concurrently; receiving, by way of said communication interface 106, the historical state metrics Z(s)ₜ^{sm} 385 of the resource; computing a second normalized state data ŝₜ² 360b based on the second current state data sₜ².

For example, for agent 180b, the platform 100 can process the second current state data sₜ² within a local scope of the order, to generate a second normalized state data ŝₜ² 360b, and provide the historical state metrics Z(s)ₜ^{sm} 385 and the second normalized state data ŝₜ² 360b to the second reinforcement learning neural network of the second automated agent 180b for training.

In some embodiments, the second normalized state data ŝₜ² 360b may be computed based on the equation:

$${\hat{s}}_{t}^{2} = \frac{{s}_{t}^{2}}{{Z ( {s}_{t}^{2} )}_{t}}$$

where sₜ² is the current state data sₜ² for the specific resource or security, represented by the stock symbol SM, in the order 337 for the agent 180b, and Z(sₜ²)ₜ is the normalized current state data for the agent 180b.

In some embodiments, a plurality of local state metrics from said first automated agent 180a may be used to compute the second normalized state data ŝₜ² 360b based on at least the second current state data sₜ² and the plurality of local state metrics from said first automated agent 180a.

As depicted in FIG. 6, trading platform 100 performs operations 600 and onward to train an automated agent 180a, 180b, 180c, sometimes in addition to performing operations 500 to train the same automated agent 180a, 180b, 180c. For example, platform 100 may perform operations 604 to 610 concurrently with operations 504 to 510. Even though each operation or step may be described with reference to agent 180a, it is understood that it can be applied to other agents 180b, 180c of the platform 100.

At operation 602, platform 100 instantiates an automated agent 180a, which may be an automated agent among a plurality of automated agents 180a, 180b, 180c that maintains a reinforcement learning neural network 110, e.g., using data descriptive of the neural network stored in data storage 120. The automated agent 180a generates, according to outputs of its reinforcement learning neural network, signals for communicating resource task requests for a given resource (e.g., a given security). For example, the automated agent 180a may receive a trade order for a given security as input data and then generate signals for a plurality of resource task requests corresponding to trades for child trade order slices of that security. Such signals may be communicated to a trading venue by way of communication interface 106.

At operation 604, platform 100 receives, by way of communication interface 106, current reward data rₜ¹ 355 of a resource for a first task completed in response to a resource task request, which may be communicated by said automated agent 180a. A completed task may occur based on the resource task request. For example, the completed task can include completed trades in a given resource (e.g., a given security) based on action aₜ_{₀}¹ 335, and current reward data rₜ¹ 355 can be computed based on current state data sₜ¹ 350 for the completed trade(s) in the order 337.

At operation 606, platform 100 receives, by way of communication interface 106, historical reward metrics Z(r)ₜ^{sm} 382 of the resource computed based on a plurality of historical tasks completed in response to a plurality of resource task requests, which may be communicated by one or more automated agents 180a, 180b, 180c. The historical reward metrics Z(r)ₜ^{sm} 382 may be stored on a database 380 and retrieved in real time or near real time.

In some embodiments, the historical reward metrics Z(r)ₜ^{sm} 382 may include one or more of: an average historical reward metric of the resource, a standard deviation of the average historical reward metric, and a normalized value based on the average historical reward metric and the standard deviation of the average historical reward metric.

Operations 604 and 606 may be performed concurrently, or operation 606 may be performed ahead of operation 604.

At operation 608, platform 100 computes compute normalized reward data \hat{r}ₜ¹ 365a based on the current reward data rₜ¹ 355. For example, for agent 180a, the platform 100 can process the current reward data rₜ¹ 355 within a local scope of the order 337, to generate a normalized reward data \hat{r}ₜ¹ 365a.

In some embodiments, computing the normalized reward data \hat{r}ₜ¹ 365a based on the current reward data rₜ¹ 355 may include: computing normalized current reward data based on the current reward data rₜ¹ 355; and computing the normalized reward data \hat{r}ₜ¹ 365a based on the normalized current state data and the current reward data rₜ¹ 355.

In some embodiments, the normalized reward data \hat{r}ₜ¹ 365a may be computed based on the equation:

$${\hat{r}}_{t}^{1} = \frac{{r}_{t}^{1}}{{Z ( {r}_{t}^{1} )}_{t}}$$

where rₜ¹ is the current reward data rₜ¹ 355 for the specific resource or security in the order 337, and Z(rₜ¹)ₜ is the normalized current reward.

For another example, the current reward data rₜ¹ 355 for agent 180a may be normalized based on a plurality of local reward metrics from one or more additional automated agents 180b, 180c.

At operation 610, platform 100 provides the normalized reward data \hat{r}ₜ¹ 365a as part of reward 375a to reinforcement learning neural network 110 of the automated agent 180a to train the automated agent 180a. In some embodiments, reward 375a further includes the historical reward metrics Z(r)ₜ^{sm} 382.

In some embodiments, the platform 100 updates the historical reward metrics Z(r)ₜ₊₁^{sm} 387 of the resource represented by the stock symbol SM for the next time step t+1 based on the order 337 completed. Where there are multiple agents 180a, 180b, 180c executing multiple orders 337 for the same resource concurrently, the platform 100 can update the historical reward metrics Z(r)ₜ₊₁^{sm} 387 of the resource based on the reward of the multiple completed orders 337. The updated historical reward metrics Z(r)ₜ₊₁^{sm} 387 may be stored in the database 380.

The training process may continue by repeating operations 604 through 610 for successive time intervals, e.g., until trade orders received as input data are completed. Conveniently, repeated performance of these operations or blocks causes automated agents 180a, 180b, 180c to become further optimized at making resources task requests, e.g., in some embodiments by improving the price of securities traded, improving the volume of securities traded, improving the timing of securities traded, and/or improving adherence to a desired trading schedule. As will be appreciated, the optimization results will vary from embodiment to embodiment.

In some embodiments, platform 100 may perform additional operations including, for example: instantiating a second automated agent 180b that maintains a second reinforcement learning neural network and generates, according to outputs of said second reinforcement learning neural network, signals for communicating resource task requests; receiving, by way of said communication interface 106, second current reward data rₜ² of the resource for a second task completed in response to a resource task request communicated by said second automated agent 180b, where the second task and the first task may be executed concurrently; receiving, by way of said communication interface 106, the historical reward metrics Z(r)ₜ^{sm} 382 of the resource; and computing a second normalized reward data \hat{r}ₜ² 365b based on the second current reward data rₜ².

For example, for agent 180b, the platform 100 can process the second current reward data rₜ² within a local scope of the order, to generate a second normalized reward data \hat{r}ₜ² 365b, and provide the historical reward metrics Z(r)ₜ^{sm} 382 and the second normalized reward data \hat{r}ₜ² 365b to the second reinforcement learning neural network of the second automated agent 180b for training.

In some embodiments, the second normalized reward data \hat{r}ₜ² 365b may be computed based on the equation:

$${\hat{r}}_{t}^{2} = \frac{{r}_{t}^{2}}{{Z ( {r}_{t}^{2} )}_{t}}$$

where rₜ² is the current reward data rₜ² for the specific resource or security in the order 337 for the agent 180b, and Z(rₜ²)ₜ is the second normalized current reward data for the agent 180b.

FIG. 4 depicts an embodiment of platform 100′ having a plurality of automated agents 180a, 180b, 180c. In this embodiment, data storage 120 stores a master model 400 that includes data defining a reinforcement learning neural network for instantiating one or more automated agents 180a, 180b, 180c.

During operation, platform 100′ instantiates a plurality of automated agents 180a, 180b, 180c according to master model 400 and performs operations depicted in FIGS. 5 and 6 for each automated agent 180a, 180b, 180c. For example, each automated agent 180a, 180b, 180c generates tasks requests 404 according to outputs of its reinforcement learning neural network 110.

As the automated agents 180a, 180b, 180c learn during operation, platform 100′ obtains updated data 406 from one or more of the automated agents 180a, 180b, 180c reflective of learnings at the automated agents 180a, 180b, 180c. Updated data 406 includes data descriptive of an “experience” of an automated agent in generating a task request. Updated data 406 may include one or more of: (i) input data to the given automated agent 180a, 180b, 180c and applied normalizations (ii) a list of possible resource task requests evaluated by the given automated agent with associated probabilities of making each requests, and (iii) one or more rewards for generating a task request.

Platform 100′ processes updated data 406 to update master model 400 according to the experience of the automated agent 180a, 180b, 180c providing the updated data 406. Consequently, automated agents 180a, 180b, 180c instantiated thereafter will have benefit of the learnings reflected in updated data 406. Platform 100′ may also sends model changes 408 to the other automated agents 180a, 180b, 180c so that these pre-existing automated agents 180a, 180b, 180c will also have benefit of the learnings reflected in updated data 406. In some embodiments, platform 100′ sends model changes 408 to automated agents 180a, 180b, 180c in quasi-real time, e.g., within a few seconds, or within one second. In one specific embodiment, platform 100′ sends model changes 408 to automated agents 180a, 180b, 180c using a stream-processing platform such as Apache Kafka, provided by the Apache Software Foundation. In some embodiments, platform 100′ processes updated data 406 to optimize expected aggregate reward across based on the experiences of a plurality of automated agents 180a, 180b, 180c.

In some embodiments, platform 100′ obtains updated data 406 after each time step. In other embodiments, platform 100′ obtains updated data 406 after a predefined number of time steps, e.g., 2, 5, 10, etc. In some embodiments, platform 100′ updates master model 400 upon each receipt updated data 406. In other embodiments, platform 100′ updates master model 400 upon reaching a predefined number of receipts of updated data 406, which may all be from one automated agent or from a plurality of automated agents 180a, 180b, 180c.

In one example, platform 100′ instantiates a first automated agent 180a, 180b, 180c and a second automated agent 180a, 180b, 180c, each from master model 400. Platform 100′ obtains updated data 406 from the first automated agents 180a, 180b, 180c. Platform 100′ modifies master model 400 in response to the updated data 406 and then applies a corresponding modification to the second automated agent 180a, 180b, 180c. Of course, the roles of the automated agents 180a, 180b, 180c could be reversed in another example such that platform 100′ obtains updated data 406 from the second automated agent 180a, 180b, 180c and applies a corresponding modification to the first automated agent 180a, 180b, 180c.

In some embodiments of platform 100′, an automated agent may be assigned all tasks for a parent order. In other embodiments, two or more automated agent 400 may cooperatively perform tasks for a parent order; for example, child slices may be distributed across the two or more automated agents 180a, 180b, 180c.

In the depicted embodiment, platform 100′ may include a plurality of I/O units 102, processors 104, communication interfaces 106, and memories 108 distributed across a plurality of computing devices. In some embodiments, each automated agent may be instantiated and/or operated using a subset of the computing devices. In some embodiments, each automated agent may be instantiated and/or operated using a subset of available processors or other compute resources. Conveniently, this allows tasks to be distributed across available compute resources for parallel execution. Other technical advantages include sharing of certain resources, e.g., data storage of the master model, and efficiencies achieved through load balancing. In some embodiments, number of automated agents 180a, 180b, 180c may be adjusted dynamically by platform 100′. Such adjustment may depend, for example, on the number of parent orders to be processed. For example, platform 100′ may instantiate a plurality of automated agents 180a, 180b, 180c in response to receive a large parent order, or a large number of parent orders. In some embodiments, the plurality of automated agents 180a, 180b, 180c may be distributed geographically, e.g., with certain of the automated agent 180a, 180b, 180c placed for geographic proximity to certain trading venues.

In some embodiments, the operation of platform 100′ adheres to a master-worker pattern for parallel processing. In such embodiments, each automated agent 180a, 180b, 180c may function as a “worker” while platform 100′ maintains the “master” by way of master model 400.

Platform 100′ is otherwise substantially similar to platform 100 described herein and each automated agent 180a, 180b, 180c is otherwise substantially similar to automated agent 180 described herein.

Pricing Features: In some embodiments, input normalization may involve the training engine 118 computing pricing features. In some embodiments, pricing features for input normalization may involve price comparison features, passive price features, gap features, and aggressive price features.

Price Comparing Features: In some embodiments, price comparison features can capture the difference between the last (most current) Bid/Ask price and the Bid/Ask price recorded at different time intervals, such as 30 minutes and 60 minutes ago: qt_Bid30, qt_Ask30, qt_Bid60, qt_Ask60. A bid price comparison feature can be normalized by the difference of a quote for a last bid/ask and a quote for a bid/ask at a previous time interval which can be divided by the market average spread. The training engine 118 can “clip” the computed values between a defined ranged or clipping bound, such as between −1 and 1, for example. There can be 30 minute differences computed using clipping bound of −5, 5 and division by 10, for example.

An Ask price comparison feature (or difference) can be computed using an Ask price instead of Bid price. For example, there can be 60-minute differences computed using clipping bound of −10, 10 and division by 10.

Passive Price: The passive price feature can be normalized by dividing a passive price by the market average spread with a clipping bound. The clipping bound can be 0, 1, for example.

Gap: The gap feature can be normalized by dividing a gap price by the market average spread with a clipping bound. The clipping bound can be 0, 1, for example.

Aggressive Price: The aggressive price feature can be normalized by dividing an aggressive price by the market average spread with a clipping bound. The clipping bound can be 0, 1, for example.

Volume and Time Features: In some embodiments, input normalization may involve the training engine 118 computing volume features and time features. In some embodiments, volume features for input normalization involves a total volume of an order, a ratio of volume remaining for order execution, and schedule satisfaction. In some embodiments, the time features for input normalization involves current time of market, a ratio of time remaining for order execution, and a ratio of order duration and trading period length.

Ratio of Order Duration and Trading Period Length: The training engine 118 can compute time features relating to order duration and trading length. The ratio of total order duration and trading period length can be calculated by dividing a total order duration by an approximate trading day or other time period in seconds, minutes, hours, and so on. There may be a clipping bound.

Current Time of the Market: The training engine 118 can compute time features relating to current time of the market. The current time of the market can be normalized by the different between the current market time and the opening time of the day (which can be a default time), which can be divided by an approximate trading day or other time period in seconds, minutes, hours, and so on.

Total Volume of the Order: The training engine 118 can compute volume features relating to the total order volume. The training engine 118 can train the reinforcement learning network 110 using the normalized order count. The total volume of the order can be normalized by dividing the total volume by a scaling factor (which can be a default value).

Ratio of time remaining for order execution: The training engine 118 can compute time features relating to the time remaining for order execution. The ratio of time remaining for order execution can be calculated by dividing the remaining order duration by the total order duration. There may be a clipping bound.

Ratio of volume remaining for order execution: The training engine 118 can compute volume features relating to the remaining order volume. The ratio of volume remaining for order execution can be calculated by dividing the remaining volume by the total volume. There may be a clipping bound.

Schedule Satisfaction: The training engine 118 can compute volume and time features relating to schedule satisfaction features. This can give the model a sense of how much time it has left compared to how much volume it has left. This is an estimate of how much time is left for order execution. A schedule satisfaction feature can be computed the a different of the remaining volume divided by the total volume and the remaining order duration divided by the total order duration. There may be a clipping bound.

VWAPs Features: In some embodiments, input normalization may involve the training engine 118 computing Volume Weighted Average Price features. In some embodiments, Volume Weighted Average Price features for input normalization may involve computing current Volume Weighted Average Price features and quoted Volume Weighted Average Price features.

Current VWAP: Current VWAP can be normalized by the current VWAP adjusted using a clipping bound, such as between −4 and 4 or 0 and 1, for example.

Quote VWAP: Quote VWAP can be normalized by the quoted VWAP adjusted using a clipping bound, such as between −3 and 3 or −1 and 1, for example.

Market Spread Features In some embodiments, input normalization may involve the training engine 118 computing market spread features. In some embodiments, market spread features for input normalization may involve spread averages computed over different time frames.

Several spread averages can be computed over different time frames according to the following equations.

Spread average: Spread average can be the difference between the bid and the ask on the exchange (e.g., on average how large is that gap). This can be the general time range for the duration of the order. The spread average can be normalized by dividing the spread average by the last trade price adjusted using a clipping bound, such as between 0 and 5 or 0 and 1, for example.

Spread σ: Spread a can be the bid and ask value at a specific time step. The spread can be normalized by dividing the spread by the last trade price adjusted using a clipping bound, such as between 0 and 2 or 0 and 1, for example.

Bounds and Bounds Satisfaction In some embodiments, input normalization may involve computing upper bounds, lower bounds, and a bounds satisfaction ratio. The training engine 118 can train the reinforcement learning network 110 using the upper bounds, the lower bounds, and the bounds satisfaction ratio.

Upper Bound: Upper bound can be normalized by multiplying an upper bound value by a scaling factor (such as 10, for example).

Lower Bound: Lower bound can be normalized by multiplying a lower bound value by a scaling factor (such as 10, for example).

Bounds Satisfaction Ratio: Bounds satisfaction ratio can be calculated by a difference between the remaining volume divided by a total volume and remaining order duration divided by a total order duration, and the lower bound can be subtracted from this difference. The result can be divided by the difference between the upper bound and the lower bound. As another example, bounds satisfaction ratio can be calculated by the difference between the schedule satisfaction and the lower bound divided by the difference between the upper bound and the lower bound.

Queue Time: In some embodiments, platform 100 measures the time elapsed between when a resource task (e.g., a trade order) is requested and when the task is completed (e.g., order filled), and such time elapsed may be referred to as a queue time. In some embodiments, platform 100 computes a reward for reinforcement learning neural network 110 that is positively correlated to the time elapsed, so that a greater reward is provided for a greater queue time. Conveniently, in such embodiments, automated agents may be trained to request tasks earlier which may result in higher priority of task completion.

Orders in the Order Book: In some embodiments, input normalization may involve the training engine 118 computing a normalized order count or volume of the order. The count of orders in the order book can be normalized by dividing the number of orders in the order book by the maximum number of orders in the order book (which may be a default value). There may be a clipping bound.

In some embodiments, the platform 100 can configured interface application 130 with different hot keys for triggering control commands which can trigger different operations by platform 100.

One Hot Key for Buy and Sell: In some embodiments, the platform 100 can configured interface application 130 with different hot keys for triggering control commands. An array representing one hot key encoding for Buy and Sell signals can be provided as follows:
Buy: [1, 0]
Sell: [0, 1]

One Hot Key for action: An array representing one hot hey encoding for task actions taken can be provided as follows:
Pass: [1, 0, 0, 0, 0, 0]
Aggressive: [0, 1, 0, 0, 0, 0,]
Top: [0, 0, 1, 0, 0, 0]
Append: [0, 0, 0, 1, 0, 0]
Prepend: [0, 0, 0, 0, 1, 0]
Pop: [0, 0, 0, 0, 0, 1]

In some embodiments, other task actions that can be requested by an automated agent include:
Far touch—go to ask
Near touch—place at bid
Layer in—if there is an order at near touch, order about near touch
Layer out—if there is an order at far touch, order close far touch
Skip—do nothing
Cancel—cancel most aggressive order

In some embodiments, the fill rate for each type of action is measured and data reflective of fill rate is included in task data received at platform 100.

In some embodiments, input normalization may involve the training engine 118 computing a normalized market quote and a normalized market trade. The training engine 118 can train the reinforcement learning network 110 using the normalized market quote and the normalized market trade.

Market Quote: Market quote can be normalized by the market quote adjusted using a clipping bound, such as between −2 and 2 or 0 and 1, for example.

Market Trade: Market trade can be normalized by the market trade adjusted using a clipping bound, such as between −4 and 4 or 0 and 1, for example.

Spam Control: The input data for automated agents 180 may include parameters for a cancel rate and/or an active rate.

Scheduler: In some embodiment, the platform 100 can include a scheduler 116. The scheduler 116 can be configured to follow a historical Volume Weighted Average Price curve to control the reinforcement learning network 110 within schedule satisfaction bounds computed using order volume and order duration. The scheduler 116 can compute schedule satisfaction data to provide the model or reinforcement learning network 110 a sense of how much time it has in comparison to how much volume remains. The schedule satisfaction data is an estimate of how much time is left for the reinforcement learning network 110 to complete the requested order or trade. For example, the scheduler 116 can compute the schedule satisfaction bounds by looking at a different between the remaining volume over the total volume and the remaining order duration over the total order duration.

In some embodiments, automated agents may train on data reflective of trading volume throughout a day, and the generation of resource requests by such automated agents need not be tied to historical volumes. For example, conventionally, some agent upon reaching historical bounds (e.g., indicative of the agent falling behind schedule) may increase aggression to stay within the bounds, or conversely may also increase passivity to stay within bounds, which may result in less optimal trades.

The scheduler 116 can be configured to follow a historical VWAP curve. The difference is that he bounds of the scheduler 116 are fairly high, and the reinforcement learning network 110 takes complete control within the bounds.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

1. A computer-implemented system for training an automated agent, the system comprising:
a communication interface;
at least one processor;
memory in communication with said at least one processor;
software code stored in said memory, which when executed at said at least one processor causes said system to:
instantiate a first automated agent that maintains a reinforcement learning neural network and generates, according to outputs of said reinforcement learning neural network, signals for communicating resource task requests;
receive, by way of said communication interface, current state data of a resource for a first task completed in response to a resource task request communicated by said first automated agent;
receive, by way of said communication interface, historical state metrics of the resource computed based on a plurality of historical tasks completed in response to a plurality of resource task requests
compute normalized state data based on the current state data; and
provide the historical state metrics and the normalized state data to the reinforcement learning neural network of said first automated agent for training.

2. The system of claim 1, wherein the historical state metrics of the resource are stored in a database and comprise at least one of: an average historical state metric of the resource, a standard deviation of the average historical state metric, and a normalized value based on the average historical state metric and the standard deviation.

3. The system of claim 1, wherein the resource is a security, and the historical state metrics and the normalized state data each comprises at least a respective slippage of the security.

4. The system of claim 1, wherein the software code, when executed at said at least one processor, causes said system to:
instantiate a second automated agent that maintains a second reinforcement learning neural network and generates, according to outputs of said second reinforcement learning neural network, signals for communicating resource task requests;
receive, by way of said communication interface, second current state data of the resource for a second task completed in response to a resource task request communicated by said second automated agent, wherein the second task and the first task are completed concurrently;
receive, by way of said communication interface, the historical state metrics of the resource;
compute a second normalized state data based on the second current state data; and
provide the historical state metrics and the second normalized state data to the second reinforcement learning neural network of said second automated agent for training.

5. The system of claim 4, wherein the software code, when executed at said at least one processor, causes said system to:
receive, by way of said communication interface, a plurality of local state metrics from said first automated agent; and
compute the second normalized state data based on at least the second current state data and the plurality of local state metrics from said first automated agent.

6. The system of claim 1, wherein the software code, when executed at said at least one processor, causes said system to:
receive, by way of said communication interface, current reward data of the resource for the first task;
receive, by way of said communication interface, historical reward metrics of the resource computed based on the plurality of historical tasks;
compute normalized reward data based on the current reward data; and
provide the historical reward metrics and the normalized reward data to the reinforcement learning neural network of said first automated agent for training.

7. The system of claim 6, wherein the historical reward metrics of the resource is stored in the database and comprises at least one of: an average historical reward metric of the resource, a standard deviation of the average historical reward metric, and a normalized value based on the average historical reward metric and the standard deviation of the average historical reward metric.

8. The system of claim 6, wherein the resource is a security, and the historical reward metrics and the normalized reward data each comprises at least a respective value determined based on a slippage of the security.

9. A computer-implemented method of training an automated agent, the method comprising:
instantiating an automated agent that maintains a reinforcement learning neural network and generates, according to outputs of said reinforcement learning neural network, signals for communicating resource task requests;
receiving, by way of said communication interface, current state data of a resource for a first task completed in response to a resource task request communicated by said automated agent;
receiving, by way of said communication interface, historical state metrics of the resource computed based on a plurality of historical tasks completed in response to a plurality of resource task requests;
computing a normalized state data based on the current state data; and
providing the historical state metrics and the normalized state data to the reinforcement learning neural network of said automated agent for training.

10. The method of claim 9, wherein the historical state metrics of the resource are stored in a database and comprise at least one of: an average historical state metric of the resource, a standard deviation of the average historical state metric, and a normalized value based on the average historical state metric and the standard deviation.

11. The method of claim 9, wherein the resource is a security, and the historical state metrics and the normalized state data each comprises at least a respective slippage of the security.

12. The method of claim 9, further comprising:
instantiating a second automated agent that maintains a second reinforcement learning neural network and generates, according to outputs of said second reinforcement learning neural network, signals for communicating resource task requests;
receiving, by way of said communication interface, second current state data of the resource for a second task completed in response to a resource task request communicated by said second automated agent, wherein the second task and the first task are completed concurrently;
receiving, by way of said communication interface, the historical state metrics of the resource;
computing a second normalized state data based on the second current state data; and
providing the historical state metrics and the second normalized state data to the second reinforcement learning neural network of said second automated agent for training.

13. The method of claim 12, further comprising:
receiving, by way of said communication interface, a plurality of local state metrics from said first automated agent; and
computing the second normalized state data based on at least the second current state data and the plurality of local state metrics from said first automated agent.

14. The method of claim 9, further comprising:
receiving, by way of said communication interface, current reward data of the resource for the first task;
receiving, by way of said communication interface, historical reward metrics of the resource computed based on the plurality of historical tasks;
computing a normalized reward data based on the current reward data; and
providing the historical reward metrics and the normalized reward data to the reinforcement learning neural network of said automated agent for training.

15. The method of claim 14, wherein the historical reward metrics of the resource is stored in the database and comprises at least one of: an average historical reward metric of the resource, a standard deviation of the average historical reward metric, and a normalized value based on the average historical reward metric and the standard deviation of the average historical reward metric.

16. The method of claim 14, wherein the resource is a security, and the historical reward metrics and the normalized reward data each comprises at least a respective value determined based on a slippage of the security.

17. A non-transitory computer-readable storage medium storing instructions which when executed adapt at least one computing device to:
instantiate an automated agent that maintains a reinforcement learning neural network and generates, according to outputs of said reinforcement learning neural network, signals for communicating resource task requests;
receive, by way of said communication interface, current state data of a resource for a first task completed in response to a resource task request communicated by said automated agent;
receive, by way of said communication interface, historical state metrics of the resource computed based on a plurality of historical tasks completed in response to a plurality of resource task requests;
compute normalized state data based on the current state data; and
provide the historical state metrics and the normalized state data to the reinforcement learning neural network of said automated agent for training.

18. The storage medium of claim 17, wherein the resource is a security, and the historical state metrics and the normalized state data each comprises at least a respective slippage of the security.

19. The storage medium of claim 17, wherein the instructions, when executed, adapt the at least one computing device to:
instantiate a second automated agent that maintains a second reinforcement learning neural network and generates, according to outputs of said second reinforcement learning neural network, signals for communicating resource task requests;
receive, by way of said communication interface, second current state data of the resource for a second task completed in response to a resource task request communicated by said second automated agent, wherein the second task and the first task are completed concurrently;
receive, by way of said communication interface, the historical state metrics of the resource;
compute a second normalized state data based on the second current state data; and
provide the historical state metrics and the second normalized state data to the second reinforcement learning neural network of said second automated agent for training.

20. The storage medium of claim 17, wherein the instructions, when executed, adapt the at least one computing device to:
receive, by way of said communication interface, current reward data of the resource for the first task;
receive, by way of said communication interface, historical reward metrics of the resource computed based on the plurality of historical tasks;
compute normalized reward data based on the current reward data; and
provide the historical reward metrics and the normalized reward data to the reinforcement learning neural network of said first automated agent for training.
